(19) United States
(12) Patent Application Publication
(10) Pub. No.: US 2003/0224662 A1
(43) Pub. Date: Dec. 4, 2003

(54) Short span compression connector for a disc drive

(75) Inventors: Ronald F. Parson, Lakeville, MN (US); Charles H.A. Smith, Apple Valley, MN (US)

Correspondence Address: Fellers, Snider, Blankenship, Bailey & Tippens, Bank One Tower, Suite 1700, 100 North Broadway, Oklahoma City, OK, 73102-8820, US

(73) Assignee: Seagate Technology LLC, Scotts Valley, CA

(21) Appl. No.: 10/273,713

(22) Filed: Oct. 18, 2002

Related U.S. Application Data
(60) Provisional application No. 60/384,940, filed on May 30, 2002.

(51) Int. Cl. H01R 12/00

(52) U.S. Cl. 439/608

(57) ABSTRACT

An apparatus for facilitating an electronic transfer of data including a compression connector housing with a clamping aperture, and a plurality of compression contacts mounted to the compression connector housing. The housing conforms to a right triangle dimensional relationship as follows: a line congruent with and substantially equal to the width of the connector housing forms a first leg of a right triangle, a line congruent with the length of the connector housing forms a second leg of the right triangle, a hypotenuse of the right triangle is formed by a line connecting the first leg to the second leg while bisecting the clamping aperture into two substantially equal portions to form the right triangle, wherein a maximum length of a second leg of the right triangle is a predetermined multiple of the length of the first leg of the right triangle.

### RELATED APPLICATIONS This application claims priority to U.S. Provisional Application No. 60/384,940 filed May 30, 2002 entitled Short-Span Compression Connector.

### FIELD OF THE INVENTION

The claimed invention relates generally to the field of digital data storage systems, and more particularly but not by way of limitation, to an apparatus and method for a short span compression connector for a data storage device.

### BACKGROUND

Disc drives are used for data storage in modern electronic products ranging from digital cameras to computers and network systems. Ordinarily, a disc drive includes a mechanical portion, or head disc assembly, and electronics in the form of a printed circuit board assembly mounted to an outer surface of the head disc assembly. The printed circuit board assembly controls functions of the head disc assembly and provides a communication interface between the disc drive and a host being serviced by the disc drive.

Typically, the head-disc assembly has a disc with a recording surface rotated at a constant speed by a spindle motor assembly and an actuator assembly positionably controlled by a closed loop servo system. The actuator assembly supports a read/write head that writes data to and reads data from the recording surface.

The disc drive market continues to place pressure on the industry for disc drives with increased capacity at a lower cost per megabyte, higher rates of data throughput between the disc drive and the host and improved reliability.

Compression-type electrical connectors have an important role to play in modern disc drive assemblies. Due to manufacturability and efficient design, compression-type connectors are often the connector of choice for head-disc assembly applications, including flex circuitry, and service between the head-disc assembly and the printed circuit board assembly of the disc drive.

As the thickness of printed circuit boards continues to decrease, the amount of flex or warpage undergone by the printed circuit board increases. This is particularly true in the region of the compression-type connector, since connector contacts put a significant load on the printed circuit board, by necessity in a direction that decreases the contact force and thus the quality of the contact.

The severity of deflection of the printed circuit board can result in acceptable performance for contacts near the clamping means of the connector and unacceptable performance for contacts further from the clamping means. A typical technique to combat such effects is to fit more clamping means, which introduces yet another series of problems.

As such, challenges remain and a need persists for improvements in compression-type electrical connectors for use in disc drive type applications

### SUMMARY OF THE INVENTION

In accordance with preferred embodiments, an apparatus for facilitating an electronic transfer of data is provided, which includes a compression connector housing with a clamping aperture, a plurality of compression contacts mounted to the compression connector housing, and a printed circuit board assembly with a contact pad corresponding with each of the plurality of compression contacts.

Each compression contact is maintained under a compressive load against corresponding contact pad by a compressive force imparted on the compressive connector housing by a fastener. The fastener includes an engagement portion and a head portion; the engagement portion passes through a fastener access aperture (sized to restrict passage of the head portion) and engages the clamping aperture. Upon full engagement with the clamping aperture a substantially uniform contact force between each of the plurality of compression contacts and each of the corresponding contact pads is attained.

Each compression contact conforms to a right triangle dimensional relationship defined by the following criteria: a connector housing with a clamping aperture, the connector housing having a length and a width; and a plurality of contacts communicating with the connector housing, wherein a line congruent with and substantially equal to the width of the connector housing forms a first leg of a right triangle, a line congruent with the length of the connector housing forms a second leg of the right triangle, a hypotenuse of the right triangle is formed by a line connecting the first leg to the second leg while bisecting the clamping aperture into two substantially equal portions to form a right triangular dimensional relationship between the width of the connector housing, the length of the connector housing and the clamping aperture of the connector housing, and further wherein a maximum length of a second leg substantially 1.5 times the length of the first leg.

These and various other features and advantages that characterize the claimed invention will be apparent upon reading the following detailed description and upon review of the associated drawings.

### BRIEF DESCRIPTION OF THE DRAWINGS

FIG. 1 is a plan view of a disc drive constructed and operated in accordance with preferred embodiments of the present invention.

FIG. 2 is a perspective view of a functionally generic short-span compression connector of the disc drive of FIG. 1.

FIG. 3 is a plan view of a short-span compression connector with a single retention feature of the disc drive of FIG. 1.

FIG. 4 is a plan view of a short-span compression connector with a plurality of retention features of the disc drive of FIG. 1.

FIG. 5 is a partial cutaway elevational view of the short-span compression connector of FIG. 3 communicating with a flex circuit and held in compressive load with a printed circuit board assembly of the disc drive of FIG. 1 by a fastener.

FIG. 6 is a partial cutaway plan view of the of the printed circuit board assembly of FIG. 5.

FIG. 7 is an elevational view of the fastener of FIG. 5.

FIG. 8 is a flow chart of a method for facilitating electronic data exchange.

### DETAILED DESCRIPTION

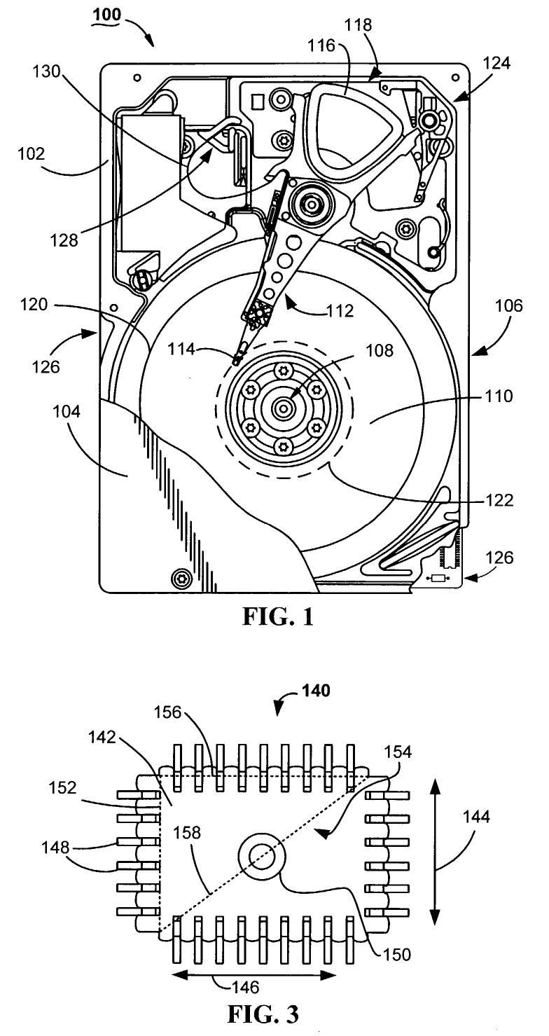

Referring now to the drawings, FIG. 1 provides a top plan view of a disc drive 100. The disc drive 100 includes a rigid base deck 102, which cooperates with a top cover 104 (shown in partial cutaway) to form a sealed housing for a mechanical portion of the disc drive 100. Typically, the mechanical portion of the disc drive 100 is referred to as a head disc assembly 106. A spindle motor 108 rotates a number of magnetic data storage discs 110 at a constant high speed. A rotary actuator 112 supports a number of data transducing heads 114 adjacent the discs 110. The actuator 112 is rotated through application of current to a coil 116 of a voice coil motor (VCM) 118.

During data transfer operations with a host device (not shown), the actuator 112 moves the heads 114 to concentric data tracks (one represented at 120) on the surfaces of the discs 110 to write data to and read data from the discs 110. When the disc drive 100 is deactivated, the actuator 112 moves the heads 114 to texturized landing zones 122; the actuator 112 is then confined by latching a toggle latch 124. Command and control electronics for the disc drive 100 are provided on a printed circuit board assembly 126 mounted to the underside of the base deck 102.

It will now be understood that the present invention (as embodied herein and as claimed below) is generally directed to a short-span compression connector for data transfer applications. In a preferred embodiment, one such application is a short-span compression connector 128 attached to a flex-circuit 130 for use in conducting signals between the heads 114 and the printed circuit board assembly 126 mounted to the underside of the head disc assembly 124.

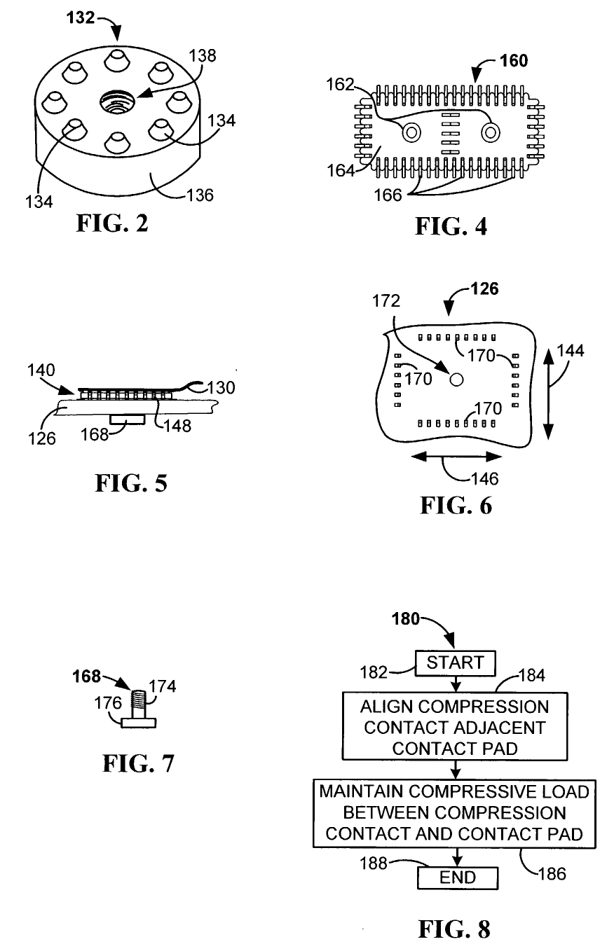

Turning to FIG. 2, shown therein is a generic short-span compression connector 132 with a plurality of compression contacts 134 supported by a connector housing 136 that includes an attachment means 138 (also referred to as clamping means 138). It is noted that the clamping means provides a reasonably symmetric clamping force to each of the plurality of compression contacts 132 absent a need for external mechanical support such as stiffeners.

In a preferred embodiment, the warpage characteristics of a mating member (such as a printed circuit board assembly 126) with the short span compression connector 132 determines a direction for mounting the short span compression connector 132 to the mating member. For example, if a maximum warpage curvature of a printed circuit board occurs in one direction, the shortest side of the compression connector 132 is aligned in that direction. The connector housing 136 is preferably of a circular configuration (or any regular polygon of more than three sides).

The preferred embodiment is not specific as to the type of compression contacts 134 used. In general, any compression connector system must have mechanical compliance somewhere in the connector system, and that is generally and most easily provided in the contact structure. Beam type contacts, knitted wire contacts, or virtually any other type of contact, which includes mechanical compliance are anticipated for use by the present invention.

The substantially symmetric housing 136 provides the clamping means 138 substantially centrally located relative to the compression contacts 134. The compression contacts 134 are configured to communicate directly with contact pads of a printed circuit board assembly. A fastener inserted through the printed circuit board assembly and communicating with the clamping means 138 provides the contact clamping force sufficient for reliable cooperation between the contact pads of the printed circuit board assembly and the compression contacts 134 of the generic short-span compression connector 132.

The configuration of the generic short-span compression connector 132 is a preferred configuration for printed circuit board assemblies that demonstrate symmetry in warpage or for mounting surfaces less susceptible to warpage, such as the actuator 112 (of FIG. 1). Note that the clamping force provided to each of the compression contacts 134 must be essentially the same, because each contact 134 is dimensionally the same distance from the axis of the clamping means 138.

Typically, a printed circuit board of a printed circuit board assembly is fabricated using a woven fiberglass base material, which has definite warp and woof directions; the board deflection in the two directions may not be equivalent. Lack of directional warpage symmetry of the printed circuit board assembly is accommodated by the present invention. As shown by FIG. 3, an alternate configuration of the preferred embodiment of the present invention is short-span compression connector 140, which contemplates asymmetric warpage of a printed circuit board assembly by presenting a compression connector housing 142 of greater length than width. The direction of the more severe warpage per unit force shown by force vector 144, is the direction selected for parallel alignment of the compression connector housing 142 along the width of the compression connector housing 142. While the direction for the less severe warpage per unit force applied, shown by force vector 146, is the direction selected for parallel alignment of the compression connector housing 142 along the length of the compression connector housing 142.

By taking into consideration be warpage characteristics of a printed circuit board assembly, a substantially constant contact force between each of a plurality of compression contacts 148 and corresponding contact pads of a mating printed circuit board assembly may be maintained while increasing the overall pin count of compression connector 140. In a preferred embodiment, each of the plurality of compression contacts 148 communicating with the connector housing 142, maintains a dimensional relationship relative to a clamping aperture 150 that assures a substantially constant contact force between each of the plurality of compression contacts 148 and corresponding contact pads of the mating printed circuit wiring board.

Because of the asymmetrical characteristics at the printed circuit board, the connector housing 142 maintains an aspect ratio (length to width) of not more than 1.5. By maintaining an aspect ratio of not more than 1.5 for the connector housing 142 and by aligning the length of the connector housing 142 parallel to force vector 146, a compressive load imparted on the clamping aperture 150 is distributed across each of the compression contacts 148 to assure proper electrical connection. Because the contact force eminates from the clamping aperture 150, the aspect ratio of 1.5 is maintained relative to the clamping aperture 150.

By adhering to the following triangular relationship, the aspect ratio of 1.5 for the compression connector housing 142 is maintained. The triangular relationship of interest occurs when the following conditions are true.

A line congruent with, and substantially equal to, the width of the compression connector housing 142 forms a first leg 152 of a right triangle 154. A line congruent with a length of the compression connector housing 142 forms a second leg 156 of the right triangle 154. A hypotenuse 158 of the right triangle 154 is formed by a line connecting the first leg 152 of the right triangle 154 to the second leg 156 of the right triangle 154 in which the line forming the hypotenuse 158 bisects the clamping aperture 150 into two substantially equal portions.

This right triangle, dimensional relationship between the width and a length of compression connector housing 142 and the clamping aperture 150 allows for short-span compression connectors of varying length. FIG. 4 shows a short-span compression connector 160 with a length substantially twice the length of the short-span connector 140 (of FIG. 3). Incorporation of a plurality of clamping apertures 162 into a connector housing 164 of the short-span compression connector 160 assures the right triangle dimensional relationship between the width and a length of the compression connector 160 and at least one of the plurality of clamping apertures 162 is maintained.

FIG. 5 shows the short-span compression connector 140 (of FIG. 3) attached to a flex circuit 130 of the disc drive 100 (of FIG. 1) and communicating with the printed circuit board assembly 126 of the disc drive 100. A predetermined substantially uniform contact force is maintained between each of the plurality of compression contacts 148 and the printed circuit board assembly 126 by an engagement of a fastener 168 with the clamping aperture 150 of FIG. 3.

A convenient technique found for securing the fastener 168 to the clamping aperture 150 is to thread the interior wall of the clamping aperture 150 and select a corresponding screw such as the fastener 168 for engagement with the interior threaded wall. However, neither use of a screw for the fastener 168 or threaded walls for the clamping aperture 150, whether used alone or in combination, constitute a limitation of the present invention. A multitude of alternative fastening techniques is well known in the art, any of which may be selected while remaining within the scope of the present invention.

FIG. 6 shows a plurality of contact pads 170 provided by the printed circuit board assembly 126. Also shown in FIG. 6 is a fastener access aperture 172 of the printed circuit board assembly 126. The fastener access aperture 172 promotes passage of the fastener 168 (of FIG. 5) for engagement with the clamping aperture 150. Each of a plurality of contact pads 170 corresponds to a specific one of the compression contacts 148 of the compression connector 140 (of FIG. 3.)

Turning to FIG. 7, shown therein is the fastener 168 (of FIG. 5) having an engagement portion 174 and a head portion 176. It is noted that the fastener access aperture 172 is sized to restrict passage of the head portion 176, of the fastener 168, while allowing passage of the engagement portion 174 of the fastener 168. While FIG. 8 shows a flow chart 180 of a method for facilitating electronic data exchange, through the use of the compression connector 140 (of FIG. 3), starting at start step 182 and continuing at process step 184. At process step 184, each of the plurality of compression contacts 148 (of FIG. 3) are aligned with a corresponding contact pad of the plurality of contact pads 170 of the printed circuit board assembly 126 (of FIG. 6.)

At process step 186, a substantially uniform contact force between each of the plurality of compression contacts 148 and one each of the corresponding plurality of contact pads 170 is attained by means for clamping each of the plurality of compression contacts 148 adjacent each of the corresponding plurality of contact pads 170. The process concludes at end step 188.

The means for maintaining the substantially uniform contact force includes a short-span compression connector housing 142 with a clamping aperture 150, the connector housing 142 supporting the plurality of compression contacts 148 (of FIG. 3). Wherein a line congruent with, and substantially equal to, the width of the compression connector housing 142 forms a first leg 152 of a right triangle 154. A line congruent with a length of the compression connector housing 142 forms a second leg 156 of the right triangle 154. A hypotenuse 158 of the right triangle 154 is formed by a line connecting the first leg 152 of the right triangle 154 to the second leg 156 of the right triangle 154 in which the line forming the hypotenuse 158 bisects the clamping aperture 150 into two substantially equal portions, wherein a maximum length of a second leg 156 of the right triangle 154 is substantially 1.5 times the length of the first leg 152 of the right triangle 154.

The compressive load developed to assure a proper connection is attained by passing the engagement portion 174 of the fastener 168 (of FIG. 7) through the fastener access aperture 172 of the printed circuit board assembly 126 (of FIG. 6) and engaging a threaded surface of the clamping aperture 150 of the compression connector housing 142 (of FIG. 3) with the engagement portion 174 of the fastener 168. By torquing the fastener 168 to full engagement with the clamping aperture 150, a substantially uniform contact force between each of the plurality of compression contacts 148 and each of the corresponding contact pads 170 is attained and maintained.

In accordance with preferred embodiments, a short-span compression connector (such as 140), with an attached flex circuit (such as 130), is positioned adjacent a printed circuit board assembly (such as 126). The printed circuit board assembly provides a contact pad (such as 170) corresponding to each of a plurality of corresponding compression contacts (such as 148) of the short-span compression connector.

Upon alignment of each of the plurality of compression contacts with each of the corresponding contact pads, a fastener (such as 168) is passed through a fastener access aperture (such as 172) of the printed circuit board assembly, and into mating contact with a clamping aperture (such as 150) of the short-span compression connector. Engagement of the fastener with the clamping aperture imparts and maintains a substantially constant contact force between each of the plurality of compression contacts of the short-span connector and the corresponding contact pads of the mating printed circuit board assembly.

Further in accordance with preferred embodiments, a data storage device (such as disc drive 100) includes a head disc assembly (such as 106) with a printed circuit board assembly (such as 126) attached to the head disc assembly, and a short-span compression connector (such as 140) attached to a flex circuit (such as 130) communicating with the printed circuit board assembly. The short-span compression connector includes a connector housing (such as 142) with a clamping aperture (such as 150), and a plurality of contacts (such as 148) communicating with the connector housing, wherein a line congruent with, and substantially equal to, the width of the compression connector housing (such as 142) forms a first leg (such as 152) of a right triangle (such as 154). A line congruent with a length of the compression connector housing forms a second leg (such as 156) of the right triangle. A hypotenuse (such as 158) of the right triangle is formed by a line connecting the first leg of the right triangle to the second leg of the right triangle in which the line forming the hypotenuse 158 bisects the clamping aperture into two substantially equal portions, wherein a maximum length of a second leg of the right triangle is substantially 1.5 times the length of the first leg of the right triangle.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed without departing from the spirit and scope of the present invention.

In addition, although the embodiments described herein are directed to an application of a short-span compression connector apparatus in a disc drive environment to facilitate data transfer, it will be appreciated by those skilled in the art that the apparatus can be applied in other types of data transfer environments without departing from the spirit and scope of the claimed invention.

What is claimed is:

1. An apparatus comprising:
a connector housing with a clamping aperture, the connector housing having a length and a width; and
a plurality of contacts communicating with the connector housing, wherein a line congruent with and substantially equal to the width of the connector housing forms a first leg of a right triangle, a line congruent with the length of the connector housing forms a second leg of the right triangle, a hypotenuse of the right triangle is formed by a line connecting the first leg to the second leg while bisecting the clamping aperture into two substantially equal portions to form a right triangular dimensional relationship between the width of the connector housing, the length of the connector housing and the clamping aperture of the connector housing, and further wherein a maximum length of a second leg of the right triangle is a predetermined multiple of the length of the first leg of the right triangle.

2. The apparatus of claim 1, in which the connector housing includes a plurality of clamping apertures, wherein each of the plurality of clamping apertures adheres positionally to the right triangular dimensional relationship.

3. The apparatus of claim 1, in which the connector housing is a compression connector housing.

4. The apparatus of claim 3, in which the plurality of contacts are compression contacts communicating with the compression connector housing.

5. The apparatus of claim 4, in which a surface of the clamping aperture is threaded.

6. The apparatus of claim 5, further comprising a fastener with an engagement portion and a head portion, the engagement portion communicating with threaded surface of the clamping aperture.

7. The apparatus of claim 6, further comprising a printed circuit board assembly with a contact pad corresponding to each of the plurality of compression contacts and a fastener aperture providing passage to the engagement portion of the fastener.

8. The apparatus of claim 7, in which the printed circuit board has an asymmetric warpage with a more severe warpage in a first direction, and in which the length of the connector housing is greater than the width of the connector housing, and wherein the width of the compression connector housing is aligned parallel to the first direction.

9. The apparatus of claim 7, in which the engagement portion of the fastener passes through the fastener aperture and engages the threaded surface of the clamping aperture of the printed circuit board assembly, the fastener aperture precluding passage of the head portion of the fastener, and further in which the fastener imparts a substantially uniform clamping force between each of the compression contacts and its corresponding contact pad upon complete engagement with the threaded surface of the clamping aperture.

10. The apparatus of claim 8, further comprising a head disc assembly with a flex circuit, the head disc assembly secured to the printed circuit board assembly and the flex circuit communicating with the compression contacts.

11. The apparatus of claim 10, in which the predetermined multiple is substantially 1.5.

12. A disc drive comprising:
a head disc assembly;
a printed circuit board assembly attached to the head disc assembly; and
a connector communicating with the printed circuit board assembly, the connector comprising:
a connector housing with a clamping aperture, the connector housing having a length and a width; and
a plurality of contacts communicating with the connector housing, wherein a line congruent with and substantially equal to the width of the connector housing forms a first leg of a right triangle, a line congruent with the length of the connector housing forms a second leg of the right triangle, a hypotenuse of the right triangle is formed by a line connecting the first leg to the second leg while bisecting the clamping aperture into two substantially equal portions to form a right triangular dimensional relationship between the width of the connector housing, the length of the connector housing and the clamping aperture of the connector housing, and further wherein a maximum length of a second leg of the right triangle is a predetermined multiple of the length of the first leg of the right triangle.

13. The disc drive of claim 12, in which the connector housing includes a plurality of clamping apertures, wherein each of the plurality of clamping apertures adheres positionally to the right triangular dimensional relationship.

14. The disc drive of claim 12, in which the connector housing is a compression connector housing.

15. The disc drive of claim 14, in which the plurality of contacts are compression contacts communicating with the compression connector housing.

16. The disc drive of claim 15, in which a surface of the clamping aperture is threaded.

17. The disc drive of claim 16, further comprising a fastener with an engagement portion and a head portion communicating with threaded surface of the clamping aperture.

18. A method of facilitating data transfer between a head disc assembly and a printed circuit board assembly by steps comprising:
aligning each of a plurality of compression contacts with a corresponding contact pad of the printed circuit board assembly; and
imparting a substantially uniform contact force between each of the plurality of compression contacts and each of the corresponding contact pads by means for clamping each of the plurality of compression contacts adjacent each of the corresponding contact pads.

19. The method of claim 18, in which the means for maintaining the substantially uniform contact force comprises a short-span compression connector having a connector housing with a clamping aperture, the connector housing having a length and a width; and a plurality of contacts communicating with the connector housing, wherein a line congruent with and substantially equal to the width of the connector housing forms a first leg of a right triangle, a line congruent with the length of the connector housing forms a second leg of the right triangle, a hypotenuse of the right triangle is formed by a line connecting the first leg to the second leg while bisecting the clamping aperture into two substantially equal portions to form a right triangular dimensional relationship between the width of the connector housing, the length of the connector housing and the clamping aperture of the connector housing, and further wherein a maximum length of a second leg of the right triangle is a predetermined multiple of the length of the first leg of the right triangle.

20. The method of claim 19, in which the imparting step comprising the steps of:
passing an engagement portion of a fastener through a fastener access aperture of the printed circuit board assembly;
engaging a threaded surface of the clamping aperture with the engagement portion of the fastener; and
torquing the fastener to apply a load on the connector housing to impart the substantially uniform contact force between each of the plurality of compression contacts and each of the corresponding contact pads.
